(19) United States
(12) Patent Application Publication
(10) Pub. No.: US 2017/0163941 A1
(43) Pub. Date: Jun. 8, 2017

(54) VIDEO ANALYTICS BASED CONTROL OF VIDEO DATA STORAGE

(71) Applicant: IWATCHLIFE, INC., Ottawa (CA)

(72) Inventors: Robert Laganiere, Gatineau (CA); William A. Murphy, Glace Bay (CA); Pascal Blais, Ottawa (CA); Jason Phillips, Lower Sackville (CA)

(21) Appl. No.: 15/437,617

(22) Filed: Feb. 21, 2017

Related U.S. Application Data
(63) Continuation of application No. 12/900,402, filed on Oct. 7, 2010, now abandoned.
(60) Provisional application No. 61/249,404, filed on Oct. 7, 2009.

(51) Int. Cl. H04N 7/18; H04N 21/2743; G08B 13/196; H04N 21/643; H04N 21/234; H04N 21/231

(52) U.S. Cl. CPC H04N 7/183; H04N 21/23418; H04N 21/23113; G08B 13/19669; H04N 21/64322; H04N 21/2743; G08B 13/19656

(57) ABSTRACT

A method comprises receiving first video data at a source end, the first video data including video data relating to an event of interest captured using a video camera disposed at the source end. The first video data is retrievably stored in a memory storage device. Video analytics is performed on the first video data to identify a first portion of the first video data that is representative of the event of interest. Subsequently, portions of the first video data other than the first portion are deleted from the memory storage device.

This Application is a continuation of U.S. patent application Ser. No. 12/900,402, filed on Oct. 7, 2010, which claims the benefit of U.S. Provisional Patent Application No. 61/249,404, filed on Oct. 7, 2009, and incorporates the disclosure of each application in its entirety by reference. To the extent that the present disclosure conflicts with any referenced application, however, the present disclosure is to be given priority.

### FIELD OF THE INVENTION

The instant invention relates generally to video analytics. More particularly the instant invention relates to a method and system for reducing the amount of space that is required to store video data, based on selective deletion of portions of video data that are stored in a video storage device. The selective deletion is performed under the control of a central server based on the results of video analytics processing of the video data.

### BACKGROUND OF THE INVENTION

Modern security and surveillance systems have come to rely very heavily on the use of video surveillance cameras for the monitoring of remote locations, entry/exit points of buildings or other restricted areas, and high-value assets, etc. The majority of surveillance video cameras that are in use today are analog. Analog video surveillance systems run coaxial cable from closed circuit television (CCTV) cameras to centrally located videotape recorders or hard drives. Increasingly, the resultant video footage is compressed on a digital video recorder (DVR) to save storage space. The use of digital video systems (DVS) is also increasing; in DVS, the analog video is digitized, compressed and packetized in IP, and then streamed to a server.

More recently, IP-networked digital video systems have been implemented. In this type of system the surveillance video is encoded directly on a digital camera, in H.264 or another suitable standard for video compression, and is sent over Ethernet at a lower bit rate. This transition from analog to digital video is bringing about long-awaited benefits to security and surveillance systems, largely because digital compression allows more video data to be transmitted and stored. Of course, a predictable result of capturing larger amounts of video data is that more personnel are required to review the video that is provided from the video surveillance cameras. Advantageously, storing the video can reduce the amount of video data that is to be reviewed, since the motion vectors and detectors that are used in compression can be used to eliminate those frames with no significant activity. However, since motion vectors and detectors offer no information as to what is occurring, someone still must physically screen the captured video to determine suspicious activity.

The market is currently seeing a migration toward IP-based hardware edge devices with built-in video analytics, such as IP cameras and encoders. Video analytics electronically recognizes the significant features within a series of frames and allows the system to issue alerts or take other actions when specific types of events occur, thereby speeding real-time security response, etc. Automatically searching the captured video for specific content also relieves personnel from tedious hours of reviewing the video, and decreases the number of personnel that is required to screen the video. Furthermore, when ‘smart’ cameras and encoders process images at the edge, they record or transmit only important events, for example only when someone enters a predefined area that is under surveillance, such as a perimeter along a fence. Accordingly, deploying an edge device is one method to reduce the strain on a network in terms of system requirements and bandwidth.

A significant problem that is associated with all of the above-mentioned systems is that the video data storage requirements are very high, especially when larger numbers of cameras are present in a system or when high-resolution video cameras are used. This problem has been ameliorated to some extent through the use of data compression algorithms, and through the use of motion detection or simple video analytics to store video data only when some predefined activity is detected within the field of view of a video camera. Unfortunately, data compression can achieve only a moderate reduction of the storage requirement before the quality of the stored data becomes insufficient for allowing additional video analytics processing to be carried out successfully. In addition, use of motion detection or simple video analytics still results in a substantial storage requirement in many instances, such as when high-resolution video cameras are used in a busy area with frequent motion within the field of view of the camera.

Accordingly, it would be advantageous to provide a method and system that overcomes at least some of the above-mentioned limitations.

### SUMMARY OF EMBODIMENTS OF THE INVENTION

In accordance with an aspect of the invention there is provided a method comprising: receiving first video data at a source end, the first video data including video data relating to an event of interest captured using a video camera disposed at the source end; retrievably storing the first video data in a memory storage device; performing video analytics on the first video data to identify a first portion of the first video data that is representative of the event of interest; and, deleting from the memory storage device portions of the first video data other than the first portion.

In accordance with an aspect of the invention there is provided a method comprising: receiving video data at a source end, the video data including video data relating to an event of interest captured using a video camera disposed at the source end; performing video analytics on the video data to identify a portion of the video data relating to the event of interest; retrievably storing in a memory storage device the portion of the video data relating to the event of interest; transmitting to a central server via a Wide Area Network (WAN), the portion of the video data relating to the event of interest; under control of the central server, performing video analytics on the portion of the video data, for identifying a subset of the portion of the video data that contains predetermined information relating to the event of interest; and, under control of the central server, deleting from the memory storage device portions of the retrievably stored portion of the video data that are other than the identified subset of the portion of the video data.

In accordance with an aspect of the invention there is provided a system comprising: a video source disposed at a source end; a central server in communication with the video source via a Wide Area Network (WAN), the central server providing video analytics processing functionality; and, a video storage device in communication with the video source and in communication with the central server via the WAN, the video storage device for retrievably storing video data that is received from the video source, wherein during use the central server controls a process for selectively erasing portions of video data that are stored in the video storage device, based on a result of video analytics processing of the video data, such that portions of the video data relating to an event of interest are stored selectively in the video storage device.

### BRIEF DESCRIPTION OF THE DRAWINGS

Exemplary embodiments of the invention will now be described in conjunction with the following drawings, wherein similar reference numerals denote similar elements throughout the several views, in which:

FIG. 1 is a simplified block diagram of a system that is suitable for implementing a method according to an embodiment of the instant invention;

FIG. 2 is a simplified block diagram of a system that is suitable for implementing a method according to an embodiment of the instant invention;

FIG. 3 is a simplified flow diagram of a method according to an embodiment of the instant invention; and,

FIG. 4 is a simplified flow diagram of a method according to an embodiment of the instant invention.

### DETAILED DESCRIPTION OF EMBODIMENTS OF THE INVENTION

The following description is presented to enable a person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the scope of the invention. Thus, the present invention is not intended to be limited to the embodiments disclosed, but is to be accorded the widest scope consistent with the principles and features disclosed herein.

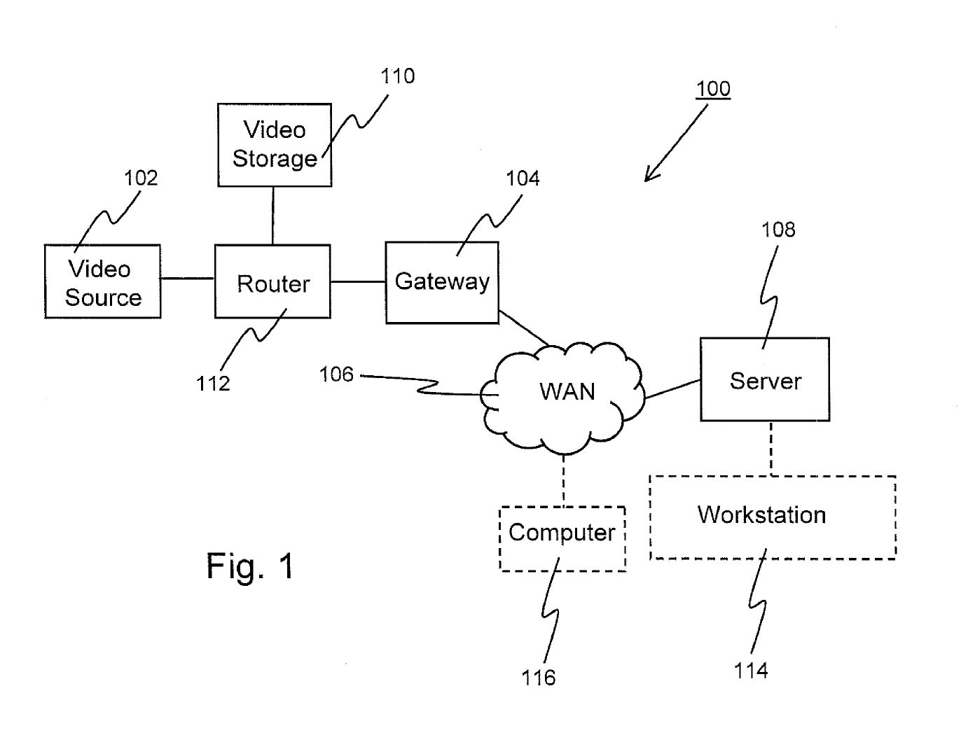

Referring now to FIG. 1, shown is a schematic block diagram of a system that is suitable for implementing a method according to an embodiment of the instant invention. The system 100 includes a video source 102, which is deployed at a source end for monitoring a known field of view (FOV). For example, the video source 102 monitors one of a parking lot, an entry/exit point of a building, and an automated teller machine (ATM). By way of a specific and non-limiting example, the video source 102 is a network IP camera with onboard video analytics capabilities, such as for instance an AXIS 211M Network Camera or another similar device. Alternatively, the video source 102 is a “dumb” IP camera or an analogue video camera, optionally coupled with a not illustrated video encoder and/or a local video analytics engine. The video source 102 is in communication with a central server 108 via router 112, gateway 104 and Wide Area Network (WAN) 106, such as for instance the Internet of the World Wide Web. In the system that is shown in FIG. 1, central server 108 comprises one or more processors for performing video analytics processing of video data that is provided from the video source 102 via WAN 106.

The system 100 further includes a video storage device 110. By way of a specific and non-limiting example, the video storage device 110 is one of a digital video recorder (DVR), and a storage device in a box with a searchable file structure. In the system that is shown in FIG. 1, the video storage device 110 is local to the source end, and is in communication with WAN 106 via router 112 and gateway 104. Optionally, the gateway 104 is omitted from the system of FIG. 1. The video storage device 110 supports read, write and erase functions. By way of a specific and non-limiting example, the video storage device 110 comprises a hard disk drive, which is a non-volatile storage device that stores digitally encoded data on rapidly rotating platters with magnetic surfaces.

The system 100 optionally includes a workstation 114, including a not illustrated processor portion, a display device and an input device. The optional workstation 114 is in communication with server 108 for supporting end-user control and video review functions. Alternatively, the server 108 and the optional workstation 114 are combined, comprising for instance a personal computer including a display and an input device. Optionally, a computer 116 is provided in communication with the WAN 106 for supporting remote access of the video data that is provided by the video source 102. For instance, a user uses a web browser application that is in execution on computer 116 for monitoring portions of the video data that are provided by the video source 102. Optionally, the computer 116 is a personal computer located at the source end, or virtually anywhere else in the world. Alternatively, the computer 116 is a mobile electronic device, such as for instance one of a cell phone, a smart phone, a PDA, or a laptop computer, etc.

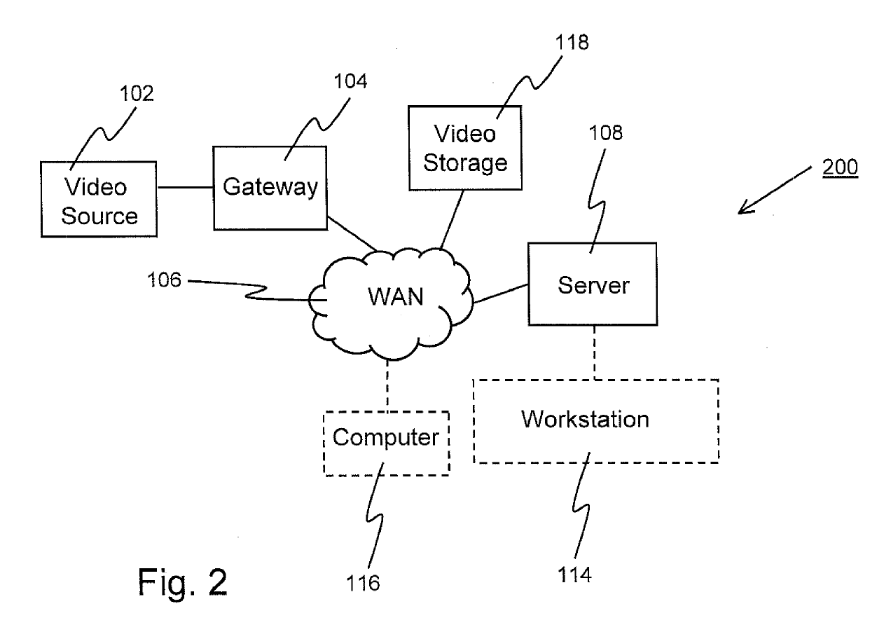

Referring now to FIG. 2, shown is a schematic block diagram of another system that is suitable for implementing a method according to an embodiment of the instant invention. The system 200 includes a video source 102, which is deployed at a source end for monitoring a known field of view (FOV). For example, the video source 102 monitors one of a parking lot, an entry/exit point of a building, and an automated teller machine (ATM). By way of a specific and non-limiting example, the video source 102 is a network IP camera with onboard video analytics capabilities, such as for instance an AXIS 211M Network Camera or another similar device. Alternatively, the video source 102 is a “dumb” IP camera or an analogue video camera, which optionally is coupled with a not illustrated video encoder and/or a local video analytics engine. The video source 102 is in communication with a central server 108 via gateway 104 and Wide Area Network (WAN) 106, such as for instance the Internet of the World Wide Web. In the system that is shown in FIG. 2, central server 108 comprises one or more processors for performing video analytics processing of video data that is provided from the video source 102 via WAN 106. Optionally, the gateway 104 is omitted from the system of FIG. 1.

The system 200 further includes a video storage device 118. By way of a specific and non-limiting example, the video storage device 118 is a network video recorder (NVR). A Network Video Recorder is an Internet protocol (IP) based device that sits on a network. The basic function of an NVR is the simultaneous recording and remote access of live video streams from an IP camera. Because they are IP based, a Network Video Recorder can be managed remotely over the WAN 106, giving greater flexibility. Alternatively, video storage device 118 is based on a server platform, which offers improved scalability compared to an NVR. The video storage device 118 supports read, write and erase functions.

The system 200 optionally includes a workstation 114, including a not illustrated processor portion, a display device and an input device. The optional workstation 114 is in communication with server 108 for supporting end-user control and video review functions. Alternatively, the server 108 and the optional workstation 114 are combined, comprising for instance a personal computer including a display and an input device. Optionally, a computer 116 is provided in communication with the WAN 106 for supporting remote access of the video data that is provided by the video source 102. For instance, a user uses a web browser application that is in execution on computer 116 for monitoring portions of the video data that are provided by the video source 102. Optionally, the computer 116 is a personal computer located at the source end, or virtually anywhere else in the world. Alternatively, the computer 116 is a mobile electronic device, such as for instance one of a cell phone, a smart phone, a PDA, or a laptop computer, etc.

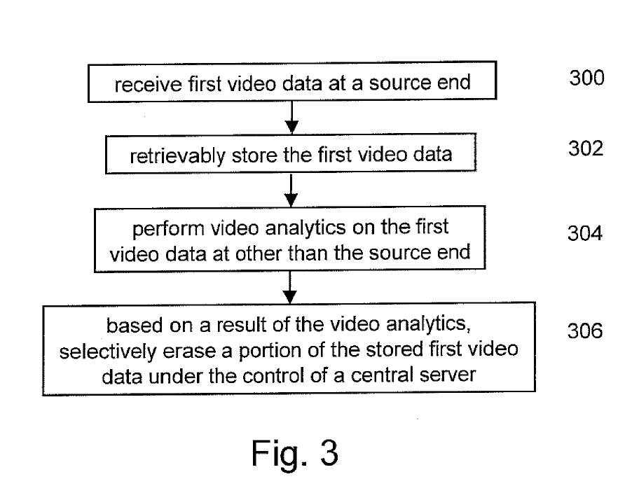

A method according to an embodiment of the instant invention is described with reference to the simplified flow diagram shown in FIG. 3, and with reference to the systems shown in FIG. 1 and FIG. 2. At 300 first video data is received at a source end, the first video data including video data relating to an event of interest captured using a video camera disposed at the source end. For instance, the video camera captures the first video data at a known frame rate, typically 30 FPS. The first video data optionally is compressed using a suitable data compression standard, such as for instance H.264 or MPEG-4. Referring now to FIG. 1, the first video data is provided via the router 112 to video storage device 110, where it is retrievably stored at 302. If the video source 102 is capable of performing video analytics, then optionally pre-processing of the first video data is performed using video analytics prior to storage of the first video data. By way of a specific and non-limiting example, video analytics is performed to determine the presence of an event of interest in the first video data and only those portions of the video data containing the event of interest are stored. Alternatively, no pre-processing using video analytics is performed and the first video data is stored in its entirety or portions of the first video data are stored according to some data storage scheme but without regard to the content of the first video data.

The first video data, either with or without preprocessing, is also provided via gateway 104 and WAN 106 to central server 108. At 304 video analytics is performed on the first video data at other than the source end. For instance, video analytics processing is performed using a not illustrated processor of central server 108. Optionally, the central server 108 has access to a plurality of different video analytics engines, which may be selected individually for performing the video analytics processing of the first video data. Alternatively, the central server 108 comprises a plurality of separate processors, each processor being capable of performing different video analytics processing of the first video data. In particular, the video analytics processing is performed to identify a first portion of the first video data that is representative of the event of interest. At 306, under control of central server 108, portions of the first video data other than the first portion are deleted from the memory storage device 110.

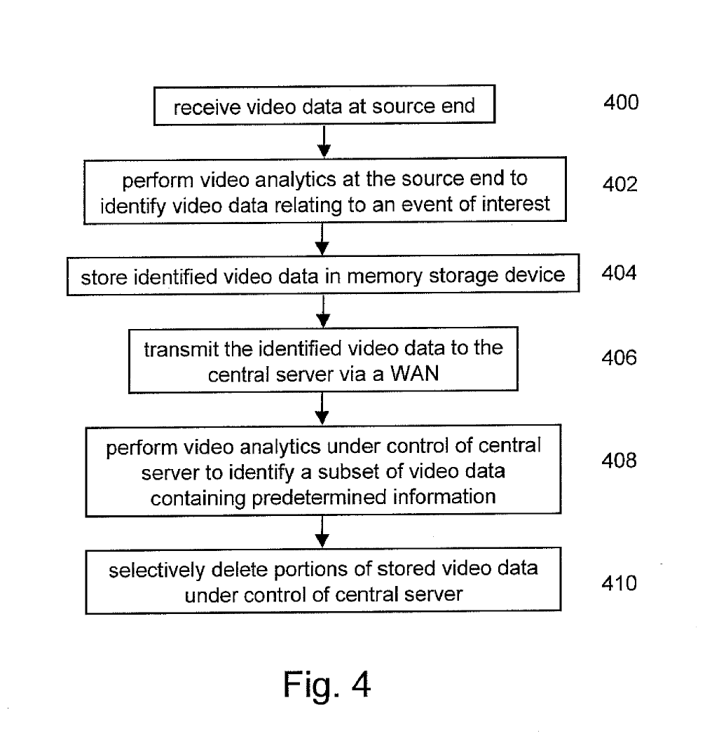

A method according to an embodiment of the instant invention is described with reference to the simplified flow diagram shown in FIG. 4, and with reference to the systems shown in FIG. 1 and FIG. 2. At 400 video data is received at a source end, the video data including video data relating to an event of interest captured using a video camera disposed at the source end. For instance, the video camera captures video data at a known frame rate, typically 30 FPS. At 402 video analytics processing is performed on the video data to identify a portion of the video data relating to the event of interest. For instance, video analytics is performed using on board processing capabilities of video source 102 or using another video analytics engine at the source end. At 404 the portion of the video data relating to the event of interest is retrievably stored in a memory storage device 118. By way of a specific and non-limiting example, frames of the video data that are captured at a time other than during an occurrence of the event of interest are discarded, such that only frames of the video data that are captured at a time during the occurrence of the event of interest are stored in the memory storage device 118. At 406 the portion of the video data relating to the event of interest is transmitted to a central server 108 via a Wide Area Network (WAN) 106. At 408, under control of the central server 108, video analytics is performed on the portion of the video data, for identifying a subset of the portion of the video data that contains predetermined information relating to the event of interest. By way of several specific and non-limiting examples, the predetermined information is one of: the facial features of an individual, the license plate of a vehicle, the number of pedestrians entering a building, the direction of travel of a vehicle or of an individual, etc. Of course, many other examples of extractable predetermined information may be readily envisaged. At 410, under control of the central server 108, portions of the retrievably stored portion of the video data, which are other than the identified subset of the portion of the video data, are deleted from the memory storage device 118. Alternatively, the deleted portions include a part of the identified subset, for example some individual frames therein, leaving sufficient data within the storage for later use.

The methods described with reference to FIG. 3 and FIG. 4 are based on the concept that an event of interest may be represented, at least in many instances, using as little as a single frame of video data, provided that the single frame of video data contains predetermined information. For instance, a camera that is set up to monitor a bank ATM may record hours of video, during which time a small number of individuals may actually enter and leave the FOV of the camera. As is apparent to one of skill in the art it is inefficient to store hours of video data that may contain only several minutes of data relating to an event of interest, such as an individual passing through the FOV of the camera. Not only does this approach require a tremendous amount of storage space for the video, but reviewing the video to find a specific individual is time consuming and tedious.

Using motion detection or other simple video analytics processing allows the video data to be selectively stored only during periods in which motion or an individual is detected within the FOV of the camera. Although this approach does achieve a significant reduction in the amount of storage space that is required to store the video, the requirement is still fairly high, especially if high-resolution cameras are used to capture the video data.

Using one of the methods that are described with reference to FIG. 3 or FIG. 4 achieves an additional reduction of the amount of storage space that is required to store the video data. In particular, video analytics performed under control of the central server 108 may be used to identify a single frame of data in a sequence of frames that provides an image of the face of an individual that is of sufficient quality to enable identification of the individual. Storage of a single frame, which meets a predetermined threshold of quality, for each individual that passes through the FOV of a camera reduces the storage requirement significantly and facilitates identification by human users, since hours of video is reduced to a series of high-quality “mug shots” that can be viewed quickly. Similarly, storage of a single frame of video data that clearly shows a vehicle license plate is sufficient for many purposes. Alternatively, storage of a sequence of frames may be required in order to accurately represent some types of events of interest. For instance, a series of frames captured over a time period of several seconds may be stored to represent the location, speed and direction of a vehicle. Optionally, storing a “time-lapse” sequence of frames, in which some intermediate frames in a sequence are omitted, further reduces the storage requirements. For instance, video analytics processing of the video data can be used to select specific frames to include in the “time-lapse” sequence, such as for instance including two or more frames showing a vehicle as it pass recognizable landmarks at known times, so as to allow a speed determination to be made in addition to a direction determination.

Referring still to FIG. 3 and FIG. 4 the video data is streamed from the video source 102 to the video storage device 110/118 and is stored therein substantially in its entirety. Optionally, the central server 108 controls the selective deletion of portions of the stored video data after a predetermined period of time has elapsed. For instance, the entire video data stream is stored for a period of one day prior to selective deletion. In this way, should the need arise, the video data for the entire predetermined period of time may be reviewed. Alternatively, selective deletion occurs automatically upon obtaining result of the video analytics processing that is performed under the control of the central server 108.

According to an alternative embodiment, video analytics processing is performed under the control of the central server 108 to identify portions of a video data stream that relate to a predetermined event of interest. In dependence upon a result of the video analytics, first portions of the video data that relate to the predetermined event are compressed for storage differently than second portions of the video data that do not relate to the predetermined events. For instance, lossless compression is used for the first portions and lossy compression is used for the second portions. Alternatively, the first portions are stored with higher resolution than the second portions. Further alternatively, the frame rate of the second portions is reduced relative to the frame rate of the first portions for storage. Yet further alternatively, in dependence upon the video analytics, different storage methodologies are employed. For example, data is stored in different locations or on different video storage devices. Alternatively, a different portion of the video frame is stored. Alternatively, the data is stored with different associations.

In an embodiment, when the system is used for facial logging, a video analytics engine determines a presence of a face and stores a video frame that contains what it determines to be a most quality facial image. Alternatively, a series of “best” facial images is stored for each identified face. Optionally, the facial image is stored in association with a first image where the individual is identified and a last image where the individual is identified. In an embodiment, for some individuals, more images are stored. For example, all images of the children are stored in case one is a good enough image to put in a photo album.

In an embodiment, a control signal is provided based on the video analytics to move the video image data from its present store to one or more further stores. For example, video of a shopper within a store is analysed and potentially stored on a security server for review by security personnel, a marketing server for review by marketing personnel, and a human resources server for review by human resources personnel. Thus, video analytics is beneficially applied to route data to different storage devices for later review or other use.

Numerous other embodiments may be envisaged without departing from the scope of the invention.

What is claimed is:

1. A method comprising:
receiving first video data at a source end, the first video data including video data relating to an event of interest captured using a video camera disposed at the source end;
retrievably storing the first video data in a memory storage device;
performing video analytics on the first video data to identify a first portion of the first video data that is representative of the event of interest; and,
deleting from the memory storage device portions of the first video data other than the first portion.

2. A method according to claim 1, comprising transmitting the first video data from the source end to a central server via a Wide Area Network (WAN), and wherein the video analytics is performed under the control of the central server.

3. A method according to claim 2, wherein the video analytics is performed using a processor of the central server.

4. A method according to claim 2, wherein the central server selects, from a plurality of available video analytics engines, a first video analytics engine for performing the video analytics, and wherein the video analytics is performed at other than the source end using the first video analytics engine.

5. A method according to claim 2, wherein deleting is controlled by the central server via the WAN.

6. A method according to claim 2, comprising providing the first video data to the central server via an IP stream, and wherein for controlling deleting the central server identifies frames of video data within the IP stream that are to be deleted.

7. A method according to claim 2, wherein the first portion of the first video data comprises a single frame of video data.

8. A method according to claim 2, wherein the memory storage device is in communication with the source end via the WAN.

9. A method according to claim 2, wherein the memory storage device comprises a network video recorder.

10. A method according to claim 2, wherein the memory storage device is local to the source end.

11. A method comprising:
receiving video data at a source end, the video data including video data relating to an event of interest captured using a video camera disposed at the source end;
performing video analytics on the video data to identify a portion of the video data relating to the event of interest;
retrievably storing in a memory storage device the portion of the video data relating to the event of interest;
transmitting to a central server via a Wide Area Network (WAN), the portion of the video data relating to the event of interest;
under control of the central server, performing video analytics on the portion of the video data, for identifying a subset of the portion of the video data that contains predetermined information relating to the event of interest; and,
under control of the central server, deleting from the memory storage device portions of the retrievably stored portion of the video data that are other than the identified subset of the portion of the video data.

12. A method according to claim 11, wherein the video analytics is performed using a processor of the central server.

13. A method according to claim 11, wherein the central server selects, from a plurality of available video analytics engines, a first video analytics engine for performing the video analytics, and wherein the video analytics is performed at other than the source end using the first video analytics engine.

14. A method according to claim 11, wherein deleting is controlled by the central server via the WAN.

15. A method according to claim 11, comprising providing the portion of the video data relating to the event of interest to the central server via an IP stream, and wherein for controlling deleting the central server identifies frames of video data within the IP stream that are to be deleted.

16. A method according to claim 11, wherein the identified subset of the portion of the video data comprises a single frame of video data.

17. A method according to claim 11, wherein the memory storage device is in communication with the source end via the WAN.

18. A method according to claim 11, wherein the memory storage device comprises a network video recorder.

19. A method according to claim 11, wherein the memory storage device is local to the source end.

20. A system comprising:
a video source disposed at a source end;
a central server in communication with the video source via a Wide Area Network (WAN), the central server providing video analytics processing functionality; and,
a video storage device in communication with the video source and in communication with the central server via the WAN, the video storage device for retrievably storing video data that is received from the video source,
wherein during use the central server controls a process for selectively erasing portions of video data that are stored in the video storage device, based on a result of video analytics processing of the video data, such that portions of the video data relating to an event of interest are stored selectively in the video storage device.
